(19) United States
(12) Patent Application Publication
(10) Pub. No.: US 2008/0188781 A1
(43) Pub. Date: Aug. 7, 2008

(54) Therapy device for biomechanical rehabilitation massage

(76) Inventors: Steve Carkner, Ottawa (CA); Leonid Blium, Limassol (CY); Heidi Dragomir, Weaverville, NC (US)

Correspondence Address: J. GORDON THOMSON, P.O. BOX 8865, VICTORIA, BC, V8V 3Z1, omitted

(21) Appl. No.: 11/306,323

(22) Filed: Dec. 22, 2005

Related U.S. Application Data
(60) Provisional application No. 60/641,014, filed on Jan. 4, 2005.

(51) Int. Cl. A61H 7/00

(52) U.S. Cl. 601/150; 601/134; 601/148; 601/149; 601/151

(57) ABSTRACT

A therapy device for biomechanical rehabilitation massage for use on CP patients comprises at least one inflatable bladder with inflation means and deflation means adapted to provide compressive forces against the body to stimulate smooth muscles in a controlled manner.

This invention relates to massage devices and in particular to an apparatus for the treatment of a living human body and specifically to a therapy device for biomechanical rehabilitation massage for the stimulation of smooth muscles and internal myofascia in persons suffering from cerebral palsy (CP) or other disorders that may result in the smooth muscles and myofascia of the body suffering from atrophy and general degradation.

### BACKGROUND OF THE INVENTION

Cerebral Palsy (CP) is a term used to describe a group of disorders affecting body movement and muscle co-ordination. The medical definition of cerebral palsy is a “non-progressive” but not unchanging disorder of movement and/or posture, due to an insult to or anomaly of the developing brain. Development of the brain starts in early pregnancy and continues until about age three. Damage to the brain during this time may result in CP. This damage interferes with messages from the brain to the body and from the body to the brain.

The effects of CP vary widely from individual to individual. At its mildest, CP may result in a slight awkwardness of movement or hand control. At its most severe, CP may result in virtually no muscle control, profoundly affecting movement and speech. Depending on which areas of the brain have been damaged, one or more of the following may occur: muscle tightness or spasms, involuntary movement, difficulty with “gross motor skills” such as walking or running, difficulty with “fine motor skills” such as writing or doing up buttons.

These effects may cause associated problems such as difficulties in feeding, poor bladder and bowel control, breathing problems, and pressure sores. The brain damage which caused CP may also lead to other conditions such as: seizures, learning disabilities or developmental delay.

CP is not a progressive condition - damage to the brain is a one-time event so it will not get worse—and people with CP have a normal lifespan. Although the condition is not progressive, the effects of CP may change over time. Some may improve: for example, a child whose hands are affected may be able to gain enough hand control to write and to dress him/herself. Others may get worse. Tight muscles can cause problems in the hips and spine of growing children which may require orthopedic surgery. The aging process can be harder on bodies with abnormal posture or which have had little exercise due to CP.

Treatment programs are tailored to individual needs and vary as new medical issues develop. Manual muscle stimulating physical and occupational therapies are important because they increase both muscle strength and tone and prevent disuse atrophy. Manual therapies and a number of known art devices exist to stimulate muscle action but these devices and therapies almost exclusively focus on the skeletal muscles. Skeletal muscles are also called voluntary muscles because they can be controlled. Examples would include the biceps which are used when lifting an object. Voluntary muscles may be stimulated by Transcutaneous Electrical Nerve Stimulation (TENS) or by moving the bones they are connected to.

Treatment programs generally ignore the smooth muscles of the body also called the involuntary muscles. Many of these muscles are used for tasks in the body that require no thought in daily life such as digestion and focusing your eyes. A number of these muscles are also used to stabilize the body especially when combined with the myofascia. The myofascia covers, supports and separates muscles. Each muscle fiber is wrapped with myofascia, bundles of those fibers are wrapped with myofascia, and the whole muscle is also wrapped in myofascia. Myofascial tissue is dynamic: under strain it increases in density and relative rigidity, giving the muscles more support. When these smooth stabilization muscles become weak, the posture, form and mobility of the body are compromised and the skeletal structure itself may begin to collapse. These muscles are often deep inside the body and are therefore impossible to reach with conventional TENS or joint-action based therapies.

In individuals with CP or similar disorders, the smooth stabilization muscles become weak because they are not challenged or addressed by any conventional therapies. For example, a child who has no control over his back muscles will therefore also not cause the back stabilization muscles and associated mesh of internal myofascia to properly develop.

Advanced Biomechanical Rehabilitation (ABR) therapy has been used for more than a decade to coax the smooth stabilization muscles to react to forces applied to the body by a care-giver's massage. This therapeutic massage is performed by applying force to specific regions of the body using the hands in a slow oscillating motion. Four critical parameters of the massage are:

The force must be applied evenly over the whole surface of the hand with no high or low pressure points using a motion that is piston-like in that it can push into the body and be withdrawn from the body in smoothly controlled movements.

The force must be applied very gradually, increasing slowly to a peak, hold the pressure, then gradually reduce the pressure. This ensures the force reaches the smooth muscles and internal myofascia deep within the body and gives them time to react.

The massage is made up of pressure cycles. Each individual pressure cycle will have an effect on the body. The massage is therefore effective from the very first application of pressure. However, the individual effects are very small, a large number of pressure cycles may therefore be required to see the benefits of the massage. It is the summation of the effects of all the pressure cycles that is most important, the overall number, duration and application of the pressure cycles may be varied as the massage progresses to ensure the appropriate application for maximum benefit. In some cases the massage will be applied for thousands of hours over the course of years, in other cases the total massage time may be only a few hundred hours.

The massage will be applied at various locations around the body. Those areas in need of treatment are accessed by the professional at a clinic. There are no specific areas of the body that will always require treatment, and similarly there are no areas of the body that never require treatment. The effects of CP vary from person to person, and so too will the application of the massage.

It is extremely difficult for care-givers to learn the proper technique to apply the ABR massage and to find the time to consistently apply the massage for hundreds and sometimes thousands of hours over the course of treatment. A device to assist in performing a therapeutic massage is therefore desired.

One example of a therapeutic massage device is described in U.S. Pat. No. 4,838,263 entitled “Chest Compression Apparatus” issued to Warwick et al on Jun. 13, 1989. The 263 patent describes a device comprising a vest-type bladder covering the chest of the individual and means for inflating and deflating the vest. The application of pressure pulses and the pulse rate is controlled by the individual. The pressure pulses are designed to be very quick and strong to dislodge mucus from the lungs. There is no need for precise control over pressure, distribution of force, or number of pressure cycles. Another example of the known art is described in U.S. Pat. No. 6,471,663 issued to Brunt and Gagne on Oct. 29, 2002 and entitled “Chest compression vest with connecting belt. The 663 patent includes an inflatable bladder that is wrapped around the chest of the individual. The bladder is inflated using compressed air and then deflated. The 663 patent describes an uncomfortable and intrusive device. It does not address the requirement for following a precise and therapeutic application of therapy that could be used to strengthen smooth muscles.

Therefore there are shortcomings in the known art of muscle therapy device that render them non-applicable to strengthening the internal smooth muscles and associated myofascia of the human body.

### SUMMARY OF THE INVENTION

In a preferred embodiment of the invention there is provided a therapy device comprising elastic inflatable bladders, a belt for placing and holding the inflatable bladders next to the body, bladder inflation means and bladder deflation means. The device is designed for in-home use by an unskilled care-giver.

The bladder inflation means and bladder deflation means are contained within a closeable case. In use, the bladders are connected to the inflation and deflation means by flexible conduits. The bladders are removably fixed to the belt and against the body in therapeutically determined and prescribed positions. When not in use, the rubber bladders, belt and conduits can be stored in the case.

More specifically the device comprises: an air intake connected to a pressurizing pump connected to a manifold. A first inflatable bladder and a second inflatable bladder are also connected to the manifold. The manifold ensures an equalization of pressure in each bladder during inflation and deflation. To deflate bladders there is an exhaust valve connected to the first and second bladders through the manifold. The bladders are rubber or latex bladders as might be used in a blood pressure monitor. They are designed to be placed next to the body of the individual in conjunction with towels or other cushioning devices during massage treatment, and they apply pressure to the body by inflating and maintaining an inflated state for a predetermined period of time. The bladders are self-deflating due to their elastic nature.

When the bladders are being deflated the pressurizing pump is used in conjunction with the deflation valve to slow the deflation rate. In this way the maximum deflation rate of the bladders is determined by the self-deflation of the bladders themselves combined with the air resistance of the deflation valve. The resistance of the deflation valve is chosen to be high enough that the pressurizing pump can pump air into the bladders faster than it exists through the valve. In this way the deflation rate will be inversely proportional to the speed of the pressurizing pump. In another embodiment a vacuum pump could be activated to draw the air from the bladders through the manifold and the vacuum pump would be chosen to have a maximum pumping volume that was less than the pressurizing pump. The bladders are attached to an elastic belt by a loop and hook system. The belt is adapted to wrap around the part of the body that is targeted for massage such as the head, torso or limb. The belt stretches to suit the placement of the bladders on limbs and torsos.

### OBJECTS AND ADVANTAGES OF THE INVENTION

It is an object of the present invention to provide a therapy device for biomechanical rehabilitation massage that can be used in at-home situations.

Another object of the present invention is to provide a therapy device for biomechanical rehabilitation massage that can be used by a care-giver with little technical or medical training.

A further object of the present invention is to provide a therapy device for biomechanical rehabilitation massage that is compatible with manual massage methodologies used for smooth muscle stimulation.

Still further objects and advantages of our invention will become apparent from a consideration of the following diagrams and detailed description.

### DESCRIPTION OF THE DRAWINGS

FIG. 1 is a schematic diagram of the air flow of our invention.

FIGS. 2A and 2B show cross-sections of a bladder of our invention.

FIG. 3 shows the force distribution on a body by the bladder of FIG. 2B.

FIG. 4 shows a schematic of the control panel of our invention.

### DETAILED DESCRIPTION

System Design.

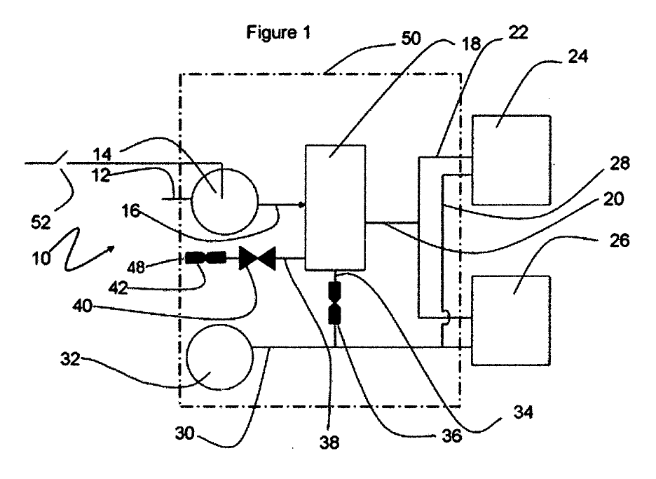

Now referring to FIG. 1 there is shown a schematic diagram of the air flow in a preferred embodiment of the system our invention (10). Our invention is a massage therapy device for biomechanical rehabilitation massage comprising means for applying at least one therapeutically effective pressure cycle to at least one therapeutically determined area of a living human body for muscle massage and means for controlling the therapeutically effective pressure cycle. Our invention is designed to exercise smooth muscles by the application of repeated pressure oscillations on various areas of the body. The invention comprises at least one inflatable bladder with inflation and deflation means. The bladder is adapted for tight placement against the therapeutically determined area of the living human body using a belt. The at least one bladder experiences an at least one therapeutically effective pressure cycle by initially inflating by inflation means to a predetermined therapeutic pressure for a first period of time and then deflating by deflation means to a second minimum therapeutic pressure for a second period of time. The therapeutic pressures and their durations are determined by a professional therapist following analysis of the living human body. The therapeutically effective pressure cycles can comprise a predetermined number of such cycles over the predetermined area of the human body to create a therapy session for that area of the body. The pressures, cycles and duration of such cycles are entered into the unit by the caregiver before each therapy session begins. Numerous areas of the human body can receive a therapy session in a predetermined sequence over the course of a day as determined by the therapy professional. The bladders are attached to a belt using a hook and loop system and the belt are adapted to hold the bladders tightly against the areas of the body receiving therapy. The belt provides a resisting force to that the therapeutic pressure is directed into the body and to the smooth muscles.

The following components of our invention are identified as follows: air intake (12), pressurizing pump (14), pressurizing pump exhaust first conduit (16), air manifold (18), air manifold inlet/outlet second conduit (20), bladder connecting third conduit (22), first bladder (24), second bladder (26), first pressure sensing conduit (28), second pressure sensing conduit (30), pressure sensor (32), restriction conduit (34), first restriction orifice (36), manifold valve conduit (38), solenoid valve (40) (or an optional vacuum pump) and restriction (42) with exhaust port (48). The dotted line (50) represents the container in which all the major components of the device are kept. The various electrical components of the device such as the pumps and valves are controlled by a controller such as a Texas Instruments MSP 430 which is not illustrated. A person skilled in the art of the control of electronic devices would know how to connect the electrical devices to the controller and therefore additional detail on the controller is not necessary in this description. Our invention also includes an operator interface as described below.

The system operates at 12VDC and a current of 2A but other voltages and currents are possible. The bladders are adapted to be placed next to the living human body during a prescribed course of massage therapy and apply pressure cycles to a specific area of the body by repeatedly inflating at a predetermined rate, holding at a therapeutically determined maximum inflation pressure for a prescribed period of time and then deflating at a predetermined rate. The bladders are held against the body by a stretch belt and are connected to the belt by a hook and loop fastening system. One such system is the VELCRO® but other fastening systems can be used. In operation, all components of the device except for the bladders (24) and (26) and the elastic belt are contained within a case (50) adapted to protect the components as well as be light and easily stored. When not in operation, the bladders and belt can also be stored within the case.

When the bladders are being pressurized, air is drawn into the system at air intake (12) and into the pressurizing pump (16). From pump (16) air is blown through conduit (16) into the manifold (18). Manifold (18) ensures that the pressure entering each of the bladders is the same. From the manifold, air is pumped into each of the bladders (24) and (26) through inflation/deflation conduit (22). Pressure in the bladders is measured through first pressure sensing conduit (28) which is connected to second pressure sensing conduit (30) and pressure gauge (32). Restriction orifice (36) is installed in conduit (34) connecting the manifold to pressure sensing line (30). The restriction orifice (36) ensures that if the sense lines from the bladders (28) (30) are blocked, or if the pressurizing lines (22) are blocked, the pressure sensor will still register a pressure that is close to the system pressure, but with somewhat reduced accuracy.

When the bladders are inflating, pressurizing pump (14) is cycled on and off by way of electrical control switch (52) connected to the controller so that there is a gradual increase in bladder pressure from a deflated state to a fully inflated state at the predetermined maximum therapeutic pressure. Pressure in the bladders is controlled by the controller connected to the pressure sensor (32). Pressure sensor (32) may be an analogue or digital sensor. The operator can view pressure within the bladders on the display panel as explained below. Once the therapeutically correct pressure is obtained the pump is shut off by the controller way of electrical control switch (52). The pressure is maintained in the bladder for a therapeutically effective period of time which can be up to five seconds. If during that time period pressure in the bladders begins to fall due to system leakage pump (14) is cycled on and off by the controller as necessary to maintain maximum pressure.

The bladders are rubber or latex and so they have an inherent elasticity to them. Like a balloon, the bladders are self-deflating and can deflate to ambient pressure.

Pump (16) is a magnetic coil driven diaphragm pump and provides air to the manifold in packets. The pump includes a check valve at the intake and outlet of the pump to ensure a consistent one-way movement of air. These check valves are integral to the pump and so are not shown as discrete items in FIG. 1. The manifold exists to smooth out air delivery to the bladders (26) and (28). The operating characteristics of pump (16) are chosen so that the inflation pressure in the system is between 0 and 2 pounds per square inch. Pump (14) can deliver air at a rate of 4 liters per minute.

Pressure sensor (32) is calibrated to ambient pressure upon start-up and has an accuracy of typically 5%. The massage treatment protocol requires very gradual increases in pressure. Therefore, the pressure sensor has very high relative accuracy capable of measuring several hundredths of a pound-per-square-inch of pressure.

In the preferred embodiment of the invention the air conduits are flexible polyurethane.

The bladders may be repeatedly cycled from a minimum therapeutic pressure to a therapeutic maximum pressure at a predetermined frequency and for a predetermined duration to create the desired massaging effect and hence stimulate deep smooth muscle tissue within the body. The number of pressure cycles at a given position on the body and the duration of the periods of maximum and minimum pressure during each cycle are predetermined by a professional and entered into the system by the caregiver.

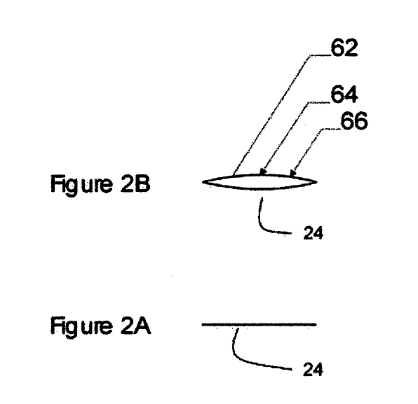

Referring now to FIGS. 2A to 2B, there is shown in cross-section a typical bladder (24) as used in the invention having a first deflated profile (FIG. 2A) under ambient pressure (deflated), a second inflated profile (FIG. 2B). The standard rubber bladder (24) is one which is typically used in blood pressure cuffs and has a flat shape when deflated as shown in FIG. 2A and a lens shape when inflated to its maximum therapeutic pressure as shown in FIG. 2B. The maximum amount of pressure exerted by the bladder in FIG. 2B on the body contact surface (62) is located at the centre of the bladder (64) and diminishes from the centre to the sides (66) of the bladder.

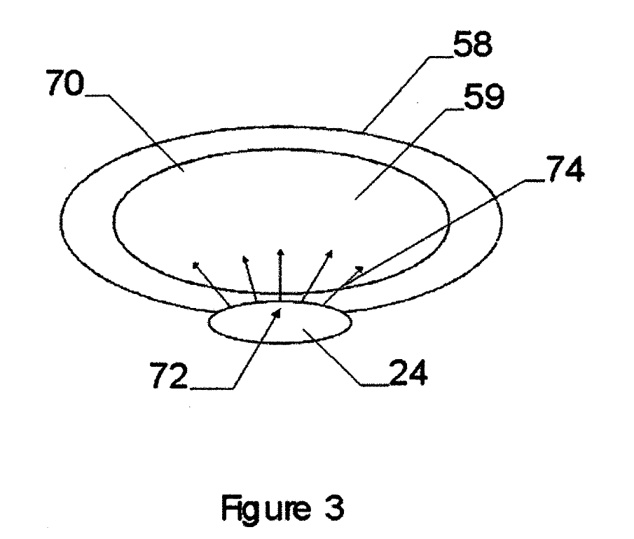

Referring to FIG. 3, the standard rubber bladder (24) is placed against towels (58) or other cushioning means which are wrapped around a human body (70) shown in cross-section. Bladder (24) will press into the towels deepest in the middle where the bladder bulges (72). The forces exerted by the rubber bladder will therefore radiate out from the bladder into the body as shown by the force lines (74) to reach deep into the body and to act upon smooth muscles located there (59). The towels (58) spread out the force from the bladder so that the central pressure point of the bladder does not cause discomfort or bruising. The towels will conform to the rounded shape of the bladder and will therefore help to better distribute the forces applied by it.

The bladder is available in three sizes: large, medium and small. The large bladder has an approximate air capacity of 300 ml. at 1 PSI.

The microprocessor controls the various components of the device such as pump operation, valve operation and the operator interface. The microprocessor may also contain an analog to digital converter to interface with the pressure sensor (32). Alternatively an external analog to digital converter may be used or a pressure sensor having a digital output may be used.

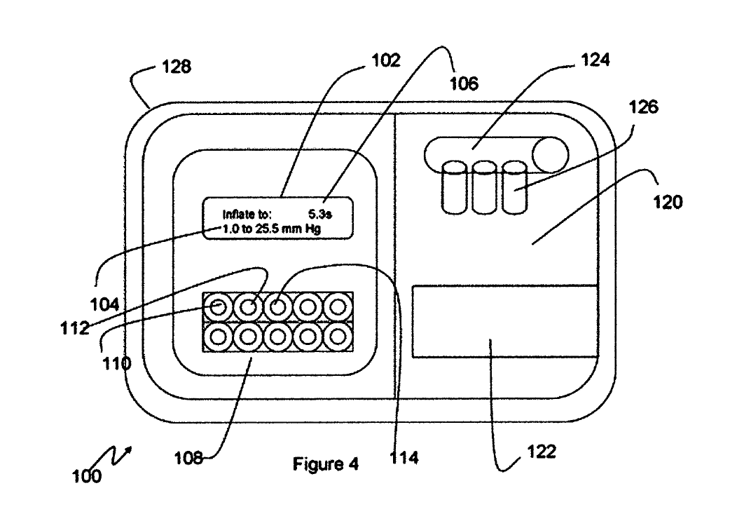

Referring to FIG. 4 there is illustrated the control consol (100) of the present invention. The invention is designed to operate in a home-care situation by a non-professional care giver with minimal training. The consol (100) is designed to provide sufficient information to the care-giver delivering the therapy to accurately enter and execute an effective massage program. Control consol (100) comprises a display screen (102) to display information to the care-giver such as pressure within the bladders in p.s.i or mm Hg (104), a countdown feature (106) during various stages of the massage therapy to inform the care-giver of the time of maximum or minimum pressures for each cycle, on/off functions and self-test functions. The display screen (102) is generally a 4 line 20 character display and is STN transflective. The display is LED and backlit in yellow/green. Below the display screen are located a plurality of push buttons (108) which contain numbers and functions to enter the parameters of the massage including maximum and minimum pressure, duration and number of cycles. Pressure in the unit is changed in a linear fashion between the maximum and minimum points entered. Through the microprocessor, the buttons can be configured to suit a desired operator interface. The display may also be set to display such indicators as massage program step (inflate bladders, hold inflation pressure at therapeutic maximum and deflate bladders) and the time remaining in the step being executed and the time remaining in the current treatment session (106). The microprocessor can be programmed to display a variety of textual displays to the operator to make operation of the device in a home environment by unskilled care-givers as easy and as effective as possible.

Next to the control consol (100) is a compartment (120) which is adapted to contain the various components of the system such as the pumps (122) and the manifold (124) with bladder connectors (126). The control consol and the components are contained within a case (128) for easy storage and transportation.

Although the description above contains much specificity, these should not be construed as limiting the scope of the invention but as merely providing illustrations of some of the presently preferred embodiments of this invention. Thus the scope of the invention should be determined by the appended claims and their legal equivalents.

What is claimed is:

1. A massage therapy device for biomechanical rehabilitation massage comprising means for applying at least one therapeutically effective pressure cycle to at least one therapeutically predetermined area of a living human body for muscle massage and means for controlling said therapeutically effective pressure cycle.

2. The device as claimed in claim 1 wherein said means for applying at least one therapeutically effective pressure cycle to said at least one therapeutically predetermined area of said human body for muscle massage comprises at least one inflatable bladder with inflation and deflation means, wherein said bladder is adapted for tight placement against the at least one therapeutically predetermined area of the human body using a belt.

3. The device as claimed in claim 2, wherein the at least one inflatable bladder experiences the at least one therapeutically effective pressure cycle by initially inflating by said inflation means to a predetermined maximum therapeutic pressure for a first period of time and subsequently to deflate by deflation means to a second minimum therapeutic pressure for a second period of time.

4. The device as claimed in claim 3 wherein said predetermined maximum therapeutic pressure, said first period of time, said predetermined minimum therapeutic pressure and said second period of time are determined by a professional following a medical analysis of said living human body.

5. The device as claimed in claim 4 wherein the at least one therapeutically effective pressure cycle comprises a predetermined number of therapeutically effective pressure cycles and further wherein said predetermined number of therapeutically effective pressure cycles comprises a session for the at least one therapeutically predetermined area of said human body.

6. The device as claimed in claim 5 wherein the at least one therapeutically predetermined area of the human body comprises a predetermined number of areas of the human body and further wherein each of said predetermined number of areas of the human body receives at least one session in a predetermined sequence.

7. The device as claimed in claim 6 wherein said predetermined sequence is repeated a predetermined number of times per day.

8. A massage therapy device for biomechanical rehabilitation massage comprising means for applying at least one therapeutically effective pressure cycle to at least one therapeutically predetermined area of a living human body for muscle massage, means for controlling said therapeutically effective pressure cycle and an operator interface, wherein said means for applying at least one therapeutically effective pressure cycle comprises a first bladder and a second bladder for tight placement against said living human body in therapeutically determined locations using a belt having an inside surface and an outside surface, wherein said first and second bladders act in cooperation, and wherein during a therapeutically effective pressure cycle the first and second bladders are inflated by inflation means to a therapeutically determined maximum pressure for a first predetermined period of time and then deflated by deflation means to a therapeutically determined minimum pressure for a second predetermined period of time.

9. The device as claimed in claim 8, wherein said inflation means comprises a pressurizing pump having an intake and an exhaust, wherein said exhaust is coupled to a first conduit for transporting pressurized air to a manifold, and wherein said manifold is adapted to receive a second conduit coupled to a third conduit for transporting pressurized air to a first bladder and a second bladder.

10. The device as claimed in claim 9 wherein the inflation means further includes a pressure sensor for monitoring pressure within the said first and second bladders, and wherein said pressure sensor is connected to the first and second bladders by connection means comprising a first and second pressure sensing conduits.

11. The device as claimed in claim 10 wherein said deflation means comprises a deflation valve in communication with the manifold and a restriction serially connected to said deflation valve so that the deflation of the first and second bladders occurs at predetermined rate.

12. The device as claimed in claim 11 further comprising a vacuum pump having an intake and an exhaust, wherein said intake is connected to the manifold, and wherein said vacuum pump is adapted to deflate the first and second bladders at a predetermined rate.

13. The device as claimed in claim 11 wherein the belt is adapted to wrap around the human body or part thereof, and further wherein the belt is adapted to hold the first and second bladders in therapeutically effective positions against the body in order to provide a resisting force so that the therapeutic maximum pressure is directed towards the body.

14. The device as claimed in claim 13 wherein said means for controlling the therapeutically effective pressure cycle comprises a programmable controller adapted for controlling the pressure of the bladders between maximum and minimum therapeutic pressures.

15. The device as claimed in claim 14, wherein said operator interface comprises a control consol adapted for easy operation by an operator with no technical or medical skills in a home environment.

16. The device as claimed in claim 15 where said control consol includes a display screen to display device operating parameters to the operator and a plurality of control buttons adapted for control of device components.

17. The device as claimed in claim 16 wherein said display screen is adapted to display a plurality of information to the operator, said plurality of information comprising: the pressure within the bladders in mm Hg., duration of time at maximum therapeutic pressure and minimum therapeutic pressure; and, on/off status.
